(19) United States
(12) Patent Application Publication
(10) Pub. No.: US 2023/0302483 A1
(43) Pub. Date: Sep. 28, 2023

(54) SYSTEM AND METHOD FOR APPLYING A WAX COATING TO A WORKPIECE DURING A STRAP-MANUFACTURING PROCESS

(71) Applicant: Signode Industrial Group LLC, Tampa, FL (US)

(72) Inventors: Tonya Clontz, Dry Ridge, KY (US); Stanislaw Witczak, Lincolnshire, IL (US); Lucas C. Scott, Northbrook, IL (US); Timothy Bangma, Grand Rapids, MI (US); Kyle Billin, Grand Rapids, MI (US); Gregory G. Lazarczyk, Granger, IN (US)

(21) Appl. No.: 18/041,171

(22) PCT Filed: Aug. 13, 2021
(86) PCT No.: PCT/US2021/045869

§ 371 Date: Feb. 9, 2023

Related U.S. Application Data
(60) Provisional application No. 63/070,986, filed on Aug. 27, 2020.

(51) Int. Cl. B05C 1/08; G05D 11/13

(52) U.S. Cl. CPC B05C 1/0873; B05C 1/083; G05D 11/138

(57) ABSTRACT

Various embodiments of the present disclosure provide a system and method for applying a wax coating to a workpiece during a strap-manufacturing process. A controller controls the flow of water and the flow of a wax solution from separate sources into a blender that blends the water and the wax solution into a blended solution. An applicator applies the blended solution to a workpiece that is then longitudinally slit and wound into coils of (waxed) strap. A sensor periodically analyzes the blended solution and sends signals to the controller, which determines the concentration of wax in the blended solution and causes a display device to display the concentration of wax in the blended solution to enable an operator to monitor the concentration of wax in the blended solution.

### PRIORITY

This application claims priority to and the benefit of U.S. Provisional Pat. Application No. 63/070,986, filed Aug. 27, 2020, the entire contents of which is incorporated herein by reference.

### FIELD

The present disclosure relates to wax-application systems and methods, and more particularly to systems and methods for applying a wax coating to a workpiece during a strap-manufacturing process.

### BACKGROUND

For decades companies have relied on metal and plastic strap to bundle products together and to secure them to pallets for transport and storage. Certain types of strap have a wax coating on their outer surface. This waxed strap has a lower coefficient of friction than un-waxed strap, which results in waxed strap moving more easily through components of strapping equipment than un-waxed strap and which results in waxed strap being less likely to snag and require equipment shutdown than un-waxed strap. The wax coating also leads to a cleaner environment in and around the strapping equipment. When un-waxed strap rubs against various components of the strapping equipment, small particles shed from the strap create “dust” in and around the strapping equipment. The wax coating reduces this friction and minimizes particle shedding. The wax coating also improves weld quality. Strapping equipment includes a weld head that, after a segment of strap is wrapped around the load, attaches the two ends of the segment of strap together. Certain weld heads, such as friction welders, generate an optimal weld when the strap has a wax coating distributed on its outer surfaces within a certain range of thicknesses. The weld heads cannot achieve this optimal weld with un-waxed strap.

In one known manufacturing process for plastic strap, resin is melted and extruded into a (continuous) workpiece that is passed over several rollers that cool the workpiece and reduce it to a specified thickness. Afterwards the workpiece is pulled through a bath filled with a water/wax solution. Some of the water/wax solution remains on the outer surface of the workpiece as it exits the bath. The workpiece is dried (either passively or actively), leaving a wax coating distributed on the outer surface of the workpiece. The workpiece is longitudinally slit and wound into individual coils of waxed strap for shipment to the customer.

This use of a water/wax solution bath to apply the wax coating to the workpiece can result in an inconsistent distribution of the wax. Upon startup of the manufacturing process, the water/wax solution has a desired concentration of wax (e.g., a desired weight percentage (wt%) of wax in the water/wax solution) that correlates to a desired distribution of the wax coating on the workpiece. This means that upon startup and for a period of time thereafter the wax coating applied to the workpiece has the desired distribution. But this does not last because the water/wax solution bath is neither constantly replenished, nor circulated, nor temperature controlled. Over time this leads to some of the wax precipitating out of the water/wax solution and settling to the bottom of the water/wax solution bath, which the workpiece does not pass through as it moves through the bath. This precipitation dilutes the remaining water/wax solution that the workpiece passes through, which means that over time the concentration of wax in the water/wax solution falls below the desired concentration of wax. This results in a thinner-than-desired distribution of wax coating on the workpiece, leading to strap with suboptimal weld performance and increased “dusting” as compared to wax with the desired thickness of wax coating. Attempts to mitigate this by increasing the initial concentration of wax in the water/wax solution above the desired concentration of wax initially results in strap with a thicker-than-desired wax coating, which leads to suboptimal welding and reduced weld strength.

### SUMMARY

Various embodiments of the present disclosure provide a system and method for applying a wax coating to a workpiece during a strap-manufacturing process. A controller controls the flow of water and the flow of a wax solution from separate sources into a blender that blends the water and the wax solution into a blended solution. An applicator applies the blended solution to a workpiece that is then longitudinally slit and wound into coils of (waxed) strap. A sensor periodically analyzes the blended solution and sends signals to the controller, which determines the concentration of wax in the blended solution and causes a display device to display the concentration of wax in the blended solution to enable an operator to monitor the concentration of wax in the blended solution.

In certain embodiments, the controller monitors the concentration of wax in the blended solution. If the concentration of wax in the blended solution differs from a wax-concentration set point that correlates to a desired thickness of the wax coating on the workpiece, the controller automatically modifies the flow of the water and/or the flow of the wax solution into to the blender such that the concentration of wax in the blended solution returns to the wax-concentration set point. By maintaining the concentration of wax in the blended solution at the wax-concentration set point, the system ensures that the workpiece has a wax coating of consistent thickness.

### BRIEF DESCRIPTION OF THE FIGURES

FIG. 1 is a block diagram of some of the components of an example embodiment of the wax-application system of the present disclosure.

FIG. 2 is a diagrammatic elevational view of the applicator of the wax-application system of FIG. 1 applying blended solution to the workpiece.

FIG. 3 is a flowchart of an example wax-application process of the present disclosure carried out by the wax-application system of FIG. 1.

FIG. 4 is a flowchart of an example wax-concentration-monitoring process of the present disclosure carried out by the wax-application system of FIG. 1.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

Various embodiments of the present disclosure provide a system and method for applying a wax coating to a workpiece during a strap-manufacturing process. A controller controls the flow of water and the flow of a wax solution from separate sources into a blender that blends the water and the wax solution into a blended solution. An applicator applies the blended solution to a workpiece that is then longitudinally slit and wound into coils of (waxed) strap. A sensor periodically analyzes the blended solution and sends signals to the controller, which determines the concentration of wax in the blended solution and causes a display device to display the concentration of wax in the blended solution to enable an operator to monitor the concentration of wax in the blended solution. In certain embodiments, the controller monitors the concentration of wax in the blended solution. If the concentration of wax in the blended solution differs from a wax-concentration set point that correlates to a desired thickness of the wax coating on the workpiece, the controller automatically modifies the flow of the water and/or the flow of the wax solution into to the blender such that the concentration of wax in the blended solution returns to the wax-concentration set point. By maintaining the concentration of wax in the blended solution at the wax-concentration set point, the system ensures that the workpiece has a wax coating of consistent thickness.

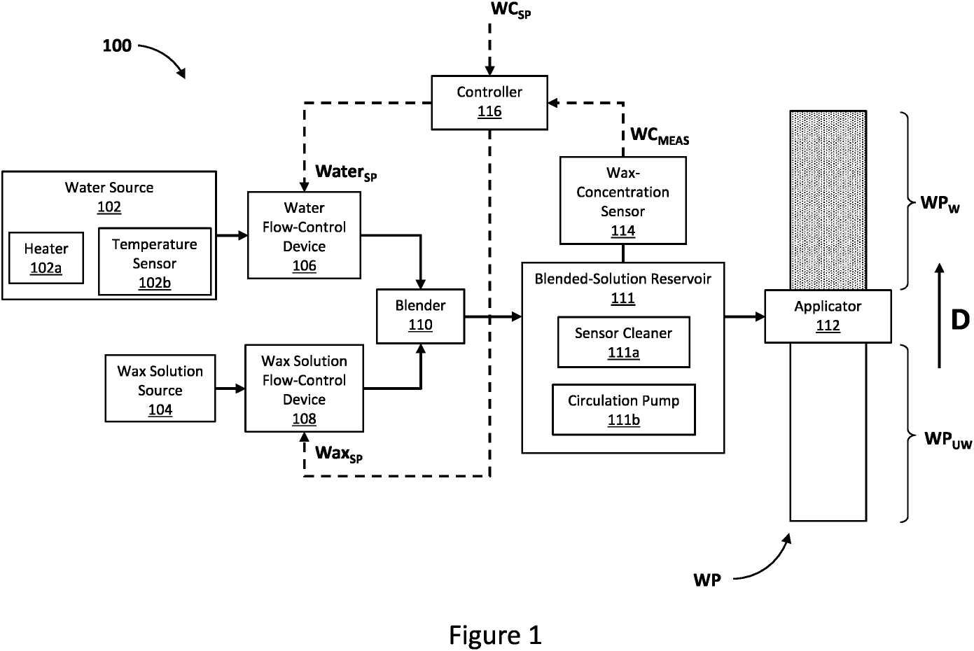

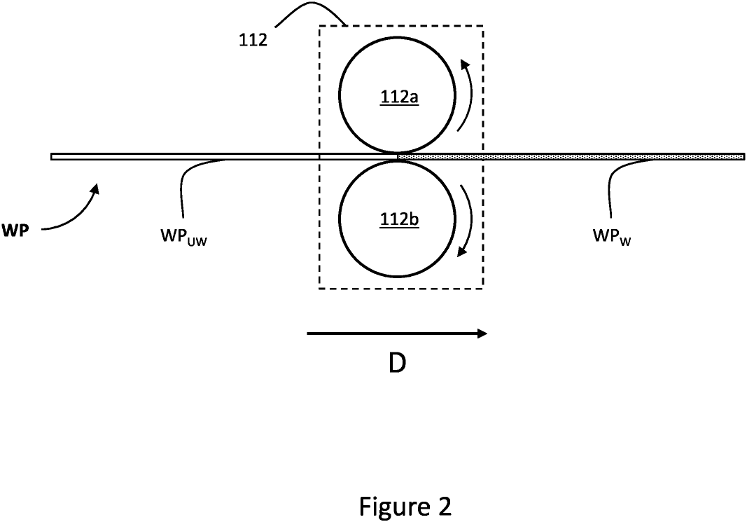

FIGS. 1 and 2 illustrate one example embodiment of a wax-application system 100 of the present disclosure and components thereof. Generally, the wax-application system 100 is operable to blend water drawn from a water source 102 with wax solution drawn from a wax-solution source 104 to create a blended solution having a desired concentration of wax to apply to a workpiece WP during a strap-manufacturing process. More specifically, in this example embodiment, the wax-application system 100 is operable to apply the blended solution to the workpiece WP after the workpiece is extruded, cooled, and thinned to a specified thickness and before the workpiece is cut to length and wound into coils of (waxed) strap (though in other embodiments the wax-application system is operable to apply the blended solution to the workpiece at any suitable point in time during the strap-manufacturing process). This example embodiment of the wax-application system 100 is therefore an “in-line” system that forms part of the strap-manufacturing process as opposed to a standalone “post-processing” system that surface treats the strap after it has been manufactured (though in other embodiments the wax-application system functions as this type of standalone post-processing system).

The wax-application system 100 includes a water flow-control device 106, a wax solution flow-control device 108, a blender 110, a blended-solution reservoir 111 including a sensor cleaner 111a and a circulation pump 111b, an applicator 112, a wax-concentration sensor 114, and a controller 116. The wax-application system 100 is fluidly connectable to the water source 102, which includes a reservoir storing deionized water (though it may store any other suitable solute in other embodiments), a heater 102a, and a temperature sensor 102b. The heater 102a is any suitable device configured to heat the water in the water source 102. The temperature sensor 102b is any suitable sensor configured to measure the temperature of the water in the water source 102 and to generate and send a signal indicative of the temperature of the water. The wax-application system 100 is also fluidly connectable to the wax-solution source 104, which includes a reservoir storing a solution of water and wax having a suitable wax concentration greater than WCₛₚ, described below. In this example embodiment, the wax is a silicone wax (though the wax may be any suitable type of wax in other embodiments).

The water flow-control device 106 is configured to control the flow of the water from the water source 102 to the blender 110 and, more particularly, the mass flow rate of the water from the water source 102 to the blender 110. The water flow-control device 106 includes a water inlet and a water outlet (not labeled) in fluid communication with one another. The water flow-control device 106 is any suitable device configured to (directly or indirectly) control the mass flow rate of the water into the blender 110 and may include, for instance, a pump, a compressor, a metering valve, or any other suitable system or component(s).

The wax solution flow-control device 108 is configured to control the flow of the wax solution from the wax solution source 104 to the blender 110 and, more particularly, the mass flow rate of the wax solution from the wax solution source 104 to the blender 110. The wax solution flow-control device 108 includes a wax solution inlet and a wax solution outlet (not labeled) in fluid communication with one another. The wax solution flow-control device 108 is any suitable device configured to (directly or indirectly) control the mass flow rate of the wax solution into the blender 110, and may include, for instance, a pump, a compressor, a metering valve, or any other suitable system or component(s).

The blender 110 is configured to receive the water and the wax solution from the water flow-control device 106 and the wax solution flow-control device 108, respectively; to actively or passively (depending on the embodiment) blend them together to create a blended solution; and to deliver the blended solution to the blended-solution reservoir 111. The blender 110 includes a water inlet, a wax-solution inlet, a blending area in fluid communication with the water and wax-solution inlets, and an outlet in fluid communication with the blending area. In this example embodiment the blender 110 is a passive blender that includes static fins that direct the water and the wax solution in such a way as to create turbulence that blends them together. In other embodiments the blender may include any suitable device configured to blend water and wax solution together, such as a driven mechanical paddle mixer.

The blended-solution reservoir 111 is any suitable reservoir, such as a tank, configured to receive the blended solution from the blender 110, store the blended solution, and deliver the blended solution to the applicator 112. The blended-solution reservoir 111 includes an inlet, an outlet in fluid communication with the inlet, a sensor cleaner 111a, and a circulation pump 111b. The sensor cleaner 111a is operably connected to and configured to clean the wax-concentration sensor 114 (described below). In this example embodiment, the sensor cleaner 111a includes a pump in fluid communication with the water source 102 (or any other suitable water source) and configured to direct pressurized water from the water source 102 onto the wax-concentration senor 114 (such as onto a lens or other sensing element of the wax-concentration sensor 114) to clean any debris off of the wax-concentration sensor 114. The sensor cleaner 111a may be any other suitable cleaning device, such as an ultrasonic cleaner. The circulation pump 111b is any suitable pump configured to circulate (either constantly or periodically depending on the embodiment) the blended solution stored in the blended-solution reservoir to help prevent wax from precipitating out of the blended solution.

The applicator 112 is configured to apply the blended solution to the outer surfaces of the workpiece WP. The applicator 112 includes a blended-solution inlet in fluid communication with the blended-solution reservoir 111. As shown in FIG. 2, in this example embodiment, the applicator 112 is a roller-type applicator that includes opposing first (upper) and second (lower) application rollers 112a and 112b that sandwich the workpiece WP therebetween. The first and second application rollers 112a and 112b each include a perforated dispenser tube covered by an absorbent roller cover (such as a felt or foam roller cover). The blended solution is introduced into the dispenser tubes and flows through the perforations in the tubes and into the roller covers, which absorb and become saturated with the blended solution. As shown in FIG. 2, the first and second application rollers 112a and 112b rotate in opposing directions and contact the outer surfaces of the workpiece WP as the workpiece WP passes between them. As this occurs, the roller covers apply the blended solution to the outer surfaces of the workpiece. This is merely one example embodiment, and the applicator 112 may include any other suitable applicator, such as a spray applicator including one or more nozzles configured to spray the blended solution onto the outer surfaces of the workpiece, a wiper applicator that wipes the blended solution on the strap, or a dip tank and squeegee.

The wax-concentration sensor 114 is configured to analyze the blended solution, generate a signal indicative of the concentration of wax in the blended solution, and transmit that signal to the controller 116. In this example embodiment, the wax-concentration sensor 114 includes a refractometer configured to determine the refractive index of the blended wax/water solution and to transmit a signal representing this refractive index to the controller 116. This is merely one example, and the wax-concentration sensor 114 may include any other suitable sensor in other embodiments, such as a pH sensor or a solution-conductivity sensor.

The controller 116 includes a central processing unit (CPU) (not shown) communicatively connected to a memory (not shown). The CPU is configured to execute program code or instructions stored on the memory to control operation of various components of the wax-application system 100. The CPU may be a microprocessor; a content-addressable memory; a digital-signal processor; an application-specific integrated circuit; a field-programmable gate array; any suitable programmable logic device, discrete gate, or transistor logic; discrete hardware components; or any combination of these. The CPU may also be implemented as a combination of these devices, such as a combination of a digital signal processor and a microprocessor, a plurality of microprocessors, or one or more microprocessors in conjunction with a digital signal processor core. The memory is configured to store, maintain, and provide data as needed to support the functionality of the wax-application system 100. For instance, in various embodiments, the memory stores program code or instructions executable by the CPU to control operation of the wax-application system 100. The memory includes any suitable data storage device or devices, such as volatile memory (e.g., random-access memory, dynamic random-access memory, or static random-access memory); non-volatile memory (e.g., read-only memory, mask read-only memory, programmable read-only memory, erasable programmable read-only memory, electrically erasable programmable read-only memory); and/or non-volatile random-access memory (e.g., flash memory, solid-state storage).

The water inlet of the water flow-control device 106 is fluidly connectable to the water source 102 to enable the water flow-control device 106 to draw water from the water source 102. The water outlet of the water flow-control device 106 is in fluid communication with the water inlet of the blender 110. The water flow-control device 106 is therefore downstream of the water source 102 and upstream of the blender 110. As used herein, “downstream” refers to the direction of fluid flow (i.e., water, wax solution, and blended solution flow) through the wax-application system 100, and “upstream” refers to the direction opposite the direction of fluid flow through the wax-application system 100.

The wax solution inlet of the wax solution flow-control device 108 is fluidly connectable to the wax solution source 104 to enable the wax solution flow-control device 108 to draw water from the wax solution source 104. The wax solution outlet of the wax solution flow-control device 108 is in fluid communication with the wax solution inlet of the blender 110. The wax solution flow-control device 108 is therefore downstream of the wax solution source 104 and upstream of the blender 110.

The outlet of the blender 110 is in fluid communication with the inlet of the blended-solution reservoir 111. The blender 110 is therefore downstream of the water and wax solution flow-control devices 106 and 108 and upstream of the blended-solution reservoir 111.

The outlet of the blended-solution reservoir 111 is in fluid communication with the blended-solution inlet of the applicator 112. The blended-solution reservoir 111 is therefore downstream of the blender 110 and upstream of the applicator 112.

The wax-concentration sensor 114 is in communication with the blended solution (such that the wax-concentration sensor can analyze the blended solution) downstream of the blender 110 and upstream of the applicator 112. In this example embodiment, the wax-concentration sensor 114 is in communication with the blended solution within the blended-solution reservoir 111, though in other embodiments the wax-concentration sensor is integrated into the blender or the applicator.

The controller 116 is communicatively connected to the wax-concentration sensor 114 to receive the signal indicative of the concentration of wax in the blended solution, which is identified herein as WC_{MEAS}. More specifically, in this example embodiment in which the wax-concentration sensor 114 includes a refractometer, WC_{MEAS} represents the refractive index of the blended wax/water solution. The controller 116 is configured to determine the concentration of the blended solution based on this refractive index, such as via a lookup table that correlates refractive indices to wax concentrations or via an algorithm stored on the memory device. The refractive index measured by the wax-concentration sensor 114 of this example embodiment is therefore indicative of the concentration of wax in the blended solution.

The controller 116 is operatively connected to the water flow-control device 106 to control the water flow-control device 106 by providing the water flow-control device 106 a water flow-control device set point Waterₛₚ. Waterₛₚ corresponds to a particular output of the water flow-control device 106 (such as a particular quantity of liters per minute if the water flow-control device 106 is a pump) that itself corresponds to a particular mass flow rate of water into the blender 110. The controller 116 is therefore configured to control the mass flow rate of water into the blender 110 via the particular Waterₛₚ the controller 116 provides to the water flow-control device 106.

Similarly, the controller 116 is operatively connected to the wax solution flow-control device 108 to control the wax solution flow-control device 108 by providing the wax solution flow-control device 108 a wax solution flow-control device set point Wax_{SP}. Wax_{SP} corresponds to a particular output of the wax solution flow-control device 108 (such as a particular quantity of liters per minute if the wax solution flow-control device 108 is a pump) that itself corresponds to a particular mass flow rate of wax solution into the blender 110. The controller 116 is therefore configured to control the mass flow rate of wax solution into the blender 110 via the particular Waxₛₚ the controller 116 provides to the wax solution flow-control device 108.

The controller 116 is communicatively connected to the temperature sensor 102b to receive the signal indicative of the temperature of the water in the water source 102. The controller 116 is operatively connected to the heater 102a. The controller 116 is configured to monitor the temperature of the water in the water source 102 and, when the measured temperature falls below a temperature set point (such as 105° F. or any other suitable temperature), controls the heater 102a to raise the temperature of the water until the measured temperature reaches the temperature set point.

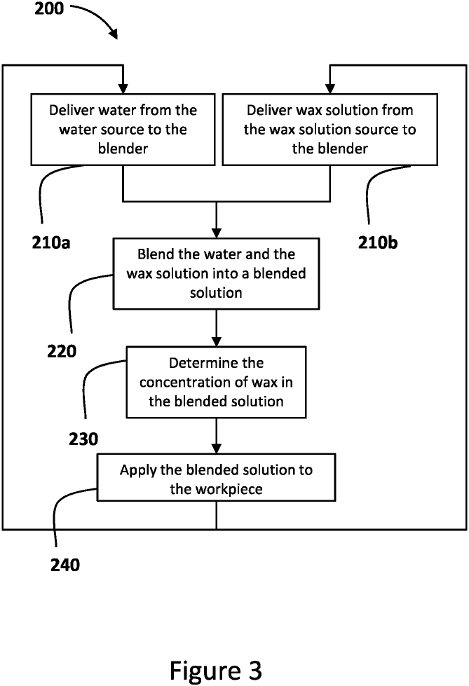

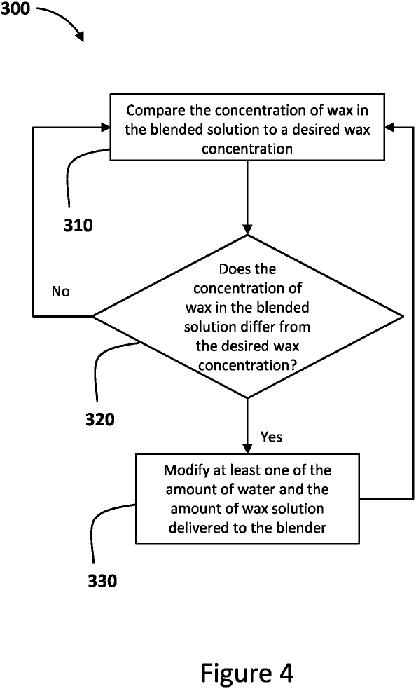

Operation of the wax-application system 100 is now described with respect to the flowcharts shown in FIG. 3 and FIG. 4. FIG. 3 is a flowchart indicative of a wax-application process 300. FIG. 4 is a flowchart indicative of a wax-concentration-monitoring process 400. As described in detail below, the controller 116 is configured to control certain components of the wax-application system 100 to carry out the wax-application process 300 and the wax-concentration-monitoring process 400 substantially simultaneously and continuously so long as the wax-application system 100 is operating.

Turning now to FIG. 3, water is delivered from the water source to the blender, as block 210a indicates. For instance, referring to the example embodiment described above and shown in FIGS. 1 and 2, the controller 116 is configured to provide Waterₛₚ (which may be stored in the memory of the controller 116) to the water flow-control device 106 to control the water flow-control device 106 to provide a corresponding mass flow rate of water into the blender 110. At the same time, wax solution is delivered from the wax solution source to the blender, as block 210b indicates. Continuing with the above example, the controller 116 is configured to provide Waxₛₚ (which may be stored in the memory of the controller 116) to the wax solution flow-control device 108 to control the wax solution flow-control device 106 to provide a corresponding mass flow rate of wax solution into the blender 110.

The water and the wax solution are then blended into a blended solution, as block 220 indicates. Continuing with the above example, the blender 110 blends the water and the wax solution received from the water and wax solution flow-control devices 106 and 108, respectively, into the blended solution. The concentration of wax in the blended solution is determined, as block 230 indicates. Continuing with the above example, the wax-concentration sensor 114 analyzes the blended solution, generates a signal indicative of the concentration of wax in the blended solution, and sends that signal to the controller 116. The controller 116 determines the concentration of wax in the blended solution based on this signal. In certain embodiments, the controller 116 causes an output device, such as a display device or a speaker, to output an indication representative of the concentration of wax in the blended solution to enable an operator to monitor the concentration of wax in the blended solution. The blended solution is then applied to the workpiece, as block 240 indicates. Continuing with the above example, the workpiece WP enters the applicator 112 via the blended-solution reservoir 111. The first and second application rollers 112a and 112b, which have rollers covers that are saturated with the blended solution, contact and apply the blended solution to the workpiece WP, which then exits the applicator 112 for further processing. WPuw identifies the portion of the workpiece before the blended solution is applied, and WPw identifies the portion of the workpiece after the blended solution is applied.

Turning to FIG. 4, as the blended solution is applied to the workpiece via the wax-application process 300, the concentration of wax in the blended solution is compared to a desired wax concentration (or in other embodiments, a desired range of wax concentrations), as block 310 indicates. If it is determined at diamond 320 that the concentration of wax in the blended solution does not differ from the desired wax concentration (or that the concentration of wax in the blended solution is within the desired range of wax concentrations), the process 300 returns to block 310. On the other hand, if it is determined at diamond 320 that the concentration of wax in the blended solution differs from the desired wax concentration (or is outside the desired range of wax concentrations), at least one of the amount of water and the amount of wax solution delivered to the blender is modified, as block 330 indicates, and the process 300 returns to block 310.

Continuing with the above example, the controller 116 stores a wax-concentration set point WCₛₚ, which represents a desired concentration of wax in the blended solution downstream of the blender 110. The wax-concentration set point WCₛₚ correlates to a wax coating of a desired thickness (or within a desired range of thicknesses) on the workpiece, and is determined in any suitable manner (such as via lookup table or via user input). In this example embodiment, WCₛₚ is 5.75 wt% wax, though it may be any other suitable concentration in other embodiments (such as a concentration between 4—6 wt% wax). The controller 116 receives WC_{MEAS}, which is the signal indicative of the concentration of wax in the blended solution, from the wax-concentration sensor 114. The controller 116 is configured to calculate the arithmetic mean, the median, or other suitable average wax concentration using multiple signals received during a time period (though in other embodiments WC_{MEAS} represents a wax concentration based on only one signal).

The controller 116 (and in this example embodiment a PID module of the controller 116) is configured to calculate the difference (if any) between WCₛₚ and WC_{MEAS} and, if WCₛₚ and WC_{MEAS} are different, controls the output of the water flow-control device 106 and/or the wax solution flow-control device 108 to reduce the difference between WCₛₚ and WC_{MEAS}. The controller 116 is configured to do so by using the difference between WCₛₚ and WC_{MEAS} to modify: (1) Waterₛₚ, which the controller 116 provides to the water flow-control device 106 to control the mass flow rate of water into the blender 110; (2) Waxₛₚ, which the controller 116 provides to the wax solution flow-control device 108 to control the mass flow rate of wax solution into the blender 110; or (3) both Waterₛp and Wax_{SP} to modify the amount of water and/or the amount of wax solution directed to the blender 110 to reduce the difference between WCₛₚ and WC_{MEAS}. In this embodiment, the controller 116 is therefore configured to modulate the output of the water flow-control device 106, the wax solution flow-control device 108, or both to converge WC_{MEAS} to WCsₚ.

In one example scenario, the controller 116 determines that WC_{MEAS} is greater than WCₛₚ, meaning that the concentration of wax in the blended solution is higher than desired. The controller 116 modifies Waterₛₚ to increase the mass flow rate of water into the blender 110, modifies Wax_{SP} to decrease the mass flow rate of wax solution into the blender 110, or both to reduce the concentration of wax in the blended solution. In an opposite example scenario, the controller determines that WC_{MEAS} is less than WCₛₚ, meaning that the concentration of wax in the blended solution is lower than desired. The controller 116 modifies Waterₛₚ to decrease the mass flow rate of water into the blender 110, modifies Waxₛₚ to increase the mass flow rate of wax solution into the blender 110, or both to increase the concentration of wax in the blended solution.

Since modifying Waterₛₚ, Waxₛₚ, or both would lead to the same result (lowering or raising the concentration of wax in the blended solution), in certain embodiments the controller determines which to do based on a target flowrate range for the blended solution. More specifically, in these embodiments, to ensure the applicator properly applies the blended solution to the workpiece, the blended solution is delivered to the applicator 112 within a target flowrate range. The controller 116 is therefore configured to modify Waterₛₚ, Waxₛₚ, or both to converge WC_{MEAS} to WCₛₚ such that the flow rate of the blended solution remains within the target flowrate range.

In this example embodiment, as the blended solution is applied to the workpiece via the wax-application process, the controller 116 also determines whether the sensor cleaner 111a should be activated to clean the wax-concentration sensor 114. Generally, the controller 116 determines whether the wax-concentration sensor 114 has been coated with debris such that it is not providing an accurate measurement of the concentration of wax in the blended solution and, in response, determines that the sensor cleaner 111a should be activated. Specifically, the controller 116 determines that the wax-concentration sensor 114 has been coated with debris when the measured concentration of wax in the blended solution has not changed more than a designated amount within a designated period of time. For instance, if the controller 116 determines that the measured concentration of was in the blended solution has not changed more than 0.05% (or any other suitable amount) within a five-minute time frame (or any other suitable time frame), the controller 116 determines that the sensor cleaner 111a should be activated to clean the wax-concentration sensor 114. In certain embodiments, the controller 116 automatically activates the sensor cleaner 111a to clean the wax-concentration sensor 111a. In other embodiments in which the sensor cleaner 111a is manually activatable by an operator, the controller 116 controls an output device (such as a display or a speaker) to output an indication instructing the operator to activate the sensor cleaner 111a. In other embodiments, the controller 116 is not configured to monitor the measured concentration of wax in the blended solution to determine whether to activate the sensor cleaner 111a and, instead, automatically activates the sensor cleaner 111a (or instructs the operator to activate the sensor cleaner 111a) according to a preset schedule (such as every five minutes). In further embodiments, the wax-application system 10 does not include a sensor cleaner 111a.

The wax-application system of the present disclosure solves the above problems. By periodically monitoring the concentration of wax in the blended solution and controlling the flow of the water and the wax solution into the blender to maintain the concentration of wax in the blended solution at the wax-concentration set point (or by providing an operator the concentration of wax in the blended solution and enabling the operator to control the flow of the water and the wax solution into the blender), the system ensures that the workpiece has a wax coating distributed at the desired thickness (or within a desired range of thicknesses).

1. A wax-application system for applying wax to a workpiece during a strap-manufacturing process, the wax-application system comprising:
a blender configured to blend a wax solution and water into a blended solution;
a water flow-control device in fluid communication with the blender and configured to deliver the water to the blender at a water mass flow rate;
a wax solution flow-control device in fluid communication with the blender and configured to deliver the wax solution to the blender at a wax solution mass flow rate;
an applicator in fluid communication with the blender and configured to apply the blended solution to the workpiece;
a sensor configured to analyze the blended solution and generate a signal indicative of a concentration of wax in the blended solution; and
a controller communicatively connected to the sensor and operably connected to the water flow-control device and the wax solution flow-control device, the controller configured to:
control the water flow-control device to deliver the water to the blender at the water mass flow rate;
control the wax solution flow-control device to deliver the wax solution to the blender at the wax solution mass flow rate;
receive the signal from the sensor; and
cause an output device to output an indication representing the concentration of wax in the blended solution.

2. The wax-application system of claim 1, wherein the output device comprises a display device.

3. The wax-application system of claim 1, wherein the controller is further configured to determine, based at least in part on the signal, whether the concentration of wax in the blended solution differs from a wax-concentration set point.

4. The wax-application system of claim 3, wherein the controller is further configured to, responsive to determining that the concentration of wax in the blended solution differs from the wax-concentration set point, control at least one of (1) the water flow-control device and (2) the wax solution flow-control device such that at least one of (a) the water mass flow rate and (b) the wax solution mass flow rate changes to reduce the difference between the concentration of wax in the blended solution and the wax-concentration set point.

5. The wax-application system of claim 4, wherein the wax-concentration set point comprises a first wax-concentration set point representing a lower bound of a desired range of wax concentrations, wherein a second wax-concentration set point represents an upper bound of the desired range of wax concentrations, wherein the controller is further configured to, responsive to determining that the concentration of wax in the blended solution is below the first wax-concentration set point or above the second wax-concentration set point, control at least one of (1) the water flow-control device and (2) the wax solution flow-control device such that at least one of (a) the water mass flow rate and (b) the wax solution mass flow rate changes to bring the concentration of wax in the blended solution into the desired range of wax concentrations.

6. The wax-application system of claim 4, wherein the controller is further configured to, responsive to determining that the concentration of wax in the blended solution is greater than the wax-concentration set point, control at least one of (1) the water flow-control device and (2) the wax solution flow-control device such that at least one of (a) the water mass flow rate increases and (b) the wax solution mass flow rate decreases to reduce the concentration of wax in the blended solution.

7. The wax-application system of claim 6, wherein the controller is further configured to, responsive to determining that the concentration of wax in the blended solution is less than the wax-concentration set point, control at least one of (1) the water flow-control device and (2) the wax solution flow-control device such that at least one of (a) the water mass flow rate decreases and (b) the wax solution mass flow rate increases to increase the concentration of wax in the blended solution.

8. The wax-application system of claim 7, wherein the controller is further configured to:
provide the water flow-control device a water flow-control device set point that corresponds to the water mass flow rate such that varying the water flow-control device set point varies the water mass flow rate,
provide the wax solution flow-control device a wax solution flow-control device set point that corresponds to the wax solution mass flow rate such that varying the wax solution flow-control device set point varies the wax solution mass flow rate,
control at least one of (1) the water flow-control device and (2) the wax solution flow-control device such that at least one of (a) the water mass flow rate increases and (b) the wax solution mass flow rate decreases by varying at least one of (x) the water flow-control device set point and (y) the wax solution flow-control device set point; and
control at least one of (1) the water flow-control device and (2) the wax solution flow-control device such that at least one of (a) the water mass flow rate decreases and (b) the wax solution mass flow rate increases by varying at least one of (x) the water flow-control device set point and (y) the wax solution flow-control device set point.

9. The wax-application system of claim 1, wherein the controller is further configured to determine the concentration of wax in the blended solution based on the signal.

10. The wax-application system of claim 9, wherein the sensor comprises a refractometer configured to determine a refractive index of the blended solution, wherein the signal represents the refractive index of the blended solution.

11. The wax-application system of claim 10, wherein the controller is further configured to:
determine, based at least in part on the signal, whether the concentration of wax in the blended solution differs from a wax-concentration set point; and
responsive to determining that the concentration of wax in the blended solution is greater than the wax-concentration set point, control at least one of (1) the water flow-control device and (2) the wax solution flow-control device such that at least one of (a) the water mass flow rate increases and (b) the wax solution mass flow rate decreases to reduce the concentration of wax in the blended solution.

12. The wax-application system of claim 11, wherein the controller is further configured to, responsive to determining that the concentration of wax in the blended solution is less than the wax-concentration set point, control at least one of (1) the water flow-control device and (2) the wax solution flow-control device such that at least one of (a) the water mass flow rate decreases and (b) the wax solution mass flow rate increases to increase the concentration of wax in the blended solution.

13. The wax-application system of claim 12, wherein the applicator comprises opposing first and second application rollers, each application roller comprising a roller cover configured to absorb the blended solution, wherein the first and second application rollers are spaced apart so the respective roller covers contact and apply the blended solution to opposing outer surfaces of the workpiece as the workpiece moves between the first and second application rollers.

14. The wax-application system of claim 13, wherein the controller is configured to:
provide the water flow-control device a water flow-control device set point that corresponds to the water mass flow rate such that varying the water flow-control device set point varies the water mass flow rate,
provide the wax solution flow-control device a wax solution flow-control device set point that corresponds to the wax solution mass flow rate such that varying the wax solution flow-control device set point varies the wax solution mass flow rate,
control at least one of (1) the water flow-control device and (2) the wax solution flow-control device such that at least one of (a) the water mass flow rate increases and (b) the wax solution mass flow rate decreases by varying at least one of (x) the water flow-control device set point and (y) the wax solution flow-control device set point; and
control at least one of (1) the water flow-control device and (2) the wax solution flow-control device such that at least one of (a) the water mass flow rate decreases and (b) the wax solution mass flow rate increases by varying at least one of (x) the water flow-control device set point and (y) the wax solution flow-control device set point.

15. The wax-application system of claim 1, wherein the applicator comprises opposing first and second application rollers, each application roller comprising a roller cover configured to absorb the blended solution, wherein the first and second application rollers are spaced apart so the respective roller covers contact and apply the blended solution to opposing outer surfaces of the workpiece as the workpiece moves between the first and second application rollers.

16. The wax-application system of claim 15, wherein the controller is further configured to:
determine, based at least in part on the signal, whether the concentration of wax in the blended solution differs from a wax-concentration set point; and
responsive to determining that the concentration of wax in the blended solution differs from a wax-concentration set point, control at least one of (1) the water flow-control device and (2) the wax solution flow-control device such that at least one of (a) the water mass flow rate and (b) the wax solution mass flow rate changes to reduce the difference between the concentration of wax in the blended solution and the wax-concentration set point.

17. The wax-application system of claim 1, wherein the controller is further configured to monitor the concentration of wax in the blended solution over time and, responsive to determining that that the concentration of wax in the blended solution has not changed at least a designated amount within a designated time period, determine that the sensor needs cleaning.

18. The wax-application system of claim 17, further comprising a sensor cleaner, wherein the controller is operably connected to the sensor cleaner and configured to activate the sensor cleaner to clean the sensor responsive to determining that the sensor needs cleaning.

19. A wax-application method for applying wax to a workpiece during a strap-manufacturing process, the method comprising:
directing water from a water source to a blender at a water mass flow rate;
directing a wax solution from a wax solution source to the blender at a wax solution mass flow rate;
blending the water and the wax solution into a blended solution;
applying the blended solution to an outer surface of the workpiece;
determining a concentration of wax in the blended solution; and
outputting an indication representing the concentration of wax in the blended solution.

20. The wax-application method of claim 19, further comprising determining whether the concentration of wax in the blended solution differs from a wax-concentration set point.

21. The wax-application method of claim 20, further comprising, responsive to determining that the concentration of wax in the blended solution differs from the wax-concentration set point, changing at least one of (a) the water mass flow rate and (b) the wax solution mass flow rate to reduce the difference between the concentration of wax in the blended solution and the wax-concentration set point.

22. The wax-application method of claim 21, wherein the wax-concentration set point comprises a first wax-concentration set point representing a lower bound of a desired range of wax concentrations, wherein a second wax-concentration set point represents an upper bound of the desired range of wax concentrations, the method further comprising, responsive to determining that the concentration of wax in the blended solution is below the first wax-concentration set point or above the second wax-concentration set point, changing at least one of (a) the water mass flow rate and (b) the wax solution mass flow rate to bring the concentration of wax in the blended solution into the desired range of wax concentrations.

23. The wax-application method of claim 21, further comprising, responsive to determining that the concentration of wax in the blended solution is greater than the wax-concentration set point, at least one of (a) increasing the water mass flow rate and (b) decreasing the wax solution mass flow rate to reduce the concentration of wax in the blended solution.

24. The wax-application method of claim 23, further comprising, responsive to determining that the concentration of wax in the blended solution is less than the wax-concentration set point, at least one of (a) decreasing the water mass flow rate and (b) increasing the wax solution mass flow rate to increase the concentration of wax in the blended solution.

25. The wax-application method of claim 19, further comprising analyzing the blended solution and generating a signal indicative of the concentration of wax in the blended solution.

26. The wax-application method of claim 25, wherein determining the concentration of wax in the blended solution comprises determining the concentration of wax in the blended solution based on the signal.

27. The wax-application method of claim 26, further comprising analyzing the blended solution with a refractometer configured to determine a refractive index of the blended solution, wherein the signal represents the refractive index of the blended solution.

28. The wax-application method of claim 19, wherein applying the blended solution to the outer surface of the workpiece comprises contacting the outer surface of the workpiece with first and second application rollers carrying the blended solution.

29. The wax-application method of claim 19, further comprising:
controlling a water flow-control device to direct the water from the water source to the blender at the water mass flow rate; and
controlling a wax solution flow-control device to direct the wax solution from the wax solution source to the blender at the wax solution mass flow rate.

30. The wax-application method of claim 29, further comprising:
controlling the water flow-control device by providing the water flow-control device a water flow-control device set point that corresponds to the water mass flow rate such that varying the water flow-control device set point varies the water mass flow rate;
controlling the wax solution flow-control device by providing the wax solution flow-control device a wax solution flow-control device set point that corresponds to the wax solution mass flow rate such that varying the wax solution flow-control device set point varies the wax solution mass flow rate;
determining whether the concentration of wax in the blended solution differs from a wax-concentration set point; and
responsive to determining that the concentration of wax in the blended solution differs from the wax-concentration set point, changing the at least one of (a) the water mass flow rate and (b) the wax solution mass flow rate to reduce the difference between the concentration of wax in the blended solution and the wax-concentration set point by varying at least one of (1) the water flow-control device set point and (2) the wax solution flow-control device set point.

31. The wax-application method of claim 19, further comprising monitoring the concentration of wax in the blended solution over time and, responsive to determining that that the concentration of wax in the blended solution has not changed at least a designated amount within a designated time period, determining that the sensor needs cleaning.

32. The wax-application method of claim 31, further comprising activating a sensor cleaner to clean the sensor responsive to determining that the sensor needs cleaning.
